(19) United States
(12) Patent Application Publication
(10) Pub. No.: US 2022/0373363 A1
(43) Pub. Date: Nov. 24, 2022

(54) Optical Microcavity Device, Alignment Structure for an Optical Device, and Method for Aligning an Optical Device

(71) Applicant: Oxford HighQ Ltd, Oxford, Oxfordshire (GB)

(72) Inventors: Ben James Ash, Oxford, Oxfordshire (GB); Robert Andrew Nyman, Oxford, Oxfordshire (GB); Jason Michael Smith, Oxford, Oxfordshire (GB); Aurélien André Paul Trichet, Oxford, Oxfordshire (GB)

(21) Appl. No.: 17/764,939

(22) PCT Filed: Sep. 15, 2020
(86) PCT No.: PCT/GB2020/052216

§ 371 Date: Mar. 29, 2022

(30) Foreign Application Priority Data
Sep. 30, 2019 (GB) 1914068.0

(51) Int. Cl. G01D 5/28; G02B 26/00

(52) U.S. Cl. CPC G01D 5/285; G02B 26/001

(57) ABSTRACT

An optical microcavity device (10), an alignment structure for an optical device, and a method for aligning an optical device are disclosed. The optical microcavity device (10) comprises: a first optical reflector (20); a second optical reflector (30) opposed to the first optical reflector (20) along an optical axis (40), the first and second optical reflectors (20, 30) being spaced from each other forming an open space therebetween; wherein the first optical reflector (20) comprises a first cavity reflector (22) and a first alignment reflector (24), wherein the second optical reflector (30) comprises a second cavity reflector (32) and a second alignment reflector (34), the second cavity reflector (32) comprising a recess to provide an optical microcavity between the first and second cavity reflectors (20, 30), the optical microcavity having an optical cavity length of at most 50 μm and/or an optical mode volume of 100 μm3 or less; an EM radiation source (50) configured for illuminating the optical microcavity with EM radiation (52) to cause multi-pass interference within the optical microcavity; and an alignment system configured to: illuminate the first and second alignment reflectors (24, 34) of the first and second optical reflectors (20, 30) to generate an optical interference pattern (74); detect the optical interference pattern (74); and determine a relative orientation and/or separation of the first and second optical reflectors (20, 30) based on the detected optical interference pattern (74); the alignment system further comprising an actuator system (100, 102) configured to move the first and second optical reflectors (20, 30) relative to each other to change the relative orientation and/or separation of the first and second optical reflectors (20, 30) based on the determined relative orientation and/or separation. At least one of the first and second alignment reflectors (20, 30) may comprise an alignment structure comprising at least two reflective surface portions having different angular orientations.

### BACKGROUND

The present specification relates to an optical microcavity device comprising an alignment system, to an optical microcavity device comprising an alignment structure, to an alignment system for an optical microcavity device, and to a method for aligning an optical microcavity device. In particular, but not exclusively, the present specification relates to an optical microcavity device in the form of a sensor, and an alignment system therefor.

An example of a microcavity device is a particle sensor including a micro-cavity for detecting particles in a fluid introduced into a sample space between the cavity reflectors. However, optical micro-cavities require careful alignment, and this requires significant skill and time. Even for an experienced user, there is a significant probability of damaging or destroying the cavity reflectors during the alignment process.

### SUMMARY

Aspects of the present disclosure are set out in the accompanying independent and dependent claims. Combinations of features from the dependent claims may be combined with features of the independent claims as appropriate and not merely as set out in the claims.

According to a first aspect of the present disclosure, there is provided an optical microcavity device as defined by the claims.

In an embodiment there is provided an optical microcavity device comprising:

a first optical reflector;

a second optical reflector opposed to the first optical reflector along an optical axis, the first and second optical reflectors being spaced from each other forming an open space therebetween;

wherein the first optical reflector comprises a first cavity reflector and a first alignment reflector,

wherein the second optical reflector comprises a second cavity reflector and a second alignment reflector, the second cavity reflector comprising a recess to provide an optical microcavity between the first and second cavity reflectors, the optical microcavity having an optical cavity length of at most 50 μm and/or an optical mode volume of 100 μm³ or less;

a first EM radiation source configured for illuminating the optical microcavity with EM radiation to cause multi-pass interference within the optical microcavity; and

an alignment system configured to:
illuminate the first and second alignment reflectors of the first and second optical reflectors with EM radiation from either the first EM radiation source or a second EM radiation source to generate an optical interference pattern;
detect the optical interference pattern; and
determine a relative orientation and/or separation of the first and second optical reflectors based on the detected optical interference pattern;

the alignment system further comprising an actuator system configured to move the first and second optical reflectors relative to each other to change the relative orientation and/or separation of the first and second optical reflectors based on the determined relative orientation and/or separation.

By including an alignment system configured to determine a relative orientation and/or separation of the first and second optical reflectors and to move the optical reflectors relative to each other to change the relative orientation and/or separation of the optical reflectors based on the relative orientation and/or separation determined by the alignment system, the optical microcavity device of the present invention is able to automatically determine and correct the alignment of the first and second optical reflectors, and therefore of the optical microcavity defined by the first and second cavity reflectors, towards a desired relative orientation and/or separation. This may save significant time, both in terms of time required to train a person to manually perform this task, and in terms of operator time required to perform the correction, and may reduce the likelihood of damage to the first and second optical reflectors during alignment. In addition, the alignment system may enable drifts in the alignment of the first and second optical reflectors to be corrected, including drifts which are faster than human operators are able to correct for, leading to improvements in stability of the optical microcavity device.

The alignment system may be configured to determine the relative orientation and/or separation of the first and second optical reflectors and to adjust the optical reflectors accordingly during a manufacturing process of the optical microcavity device, or during use of the optical microcavity device. For example, in the case of an optical microcavity device in the form of a sensing device, the alignment system may be used to determine and adjust the relative orientation and/or separation of the first and second optical reflectors prior to a measurement or sample detection.

The alignment system may be configured to move the first and second optical reflectors relative to each other, to change the relative orientation and/or separation of the first and second optical reflectors to a desired orientation and/or separation, either in a single step, or in a series of steps. The alignment system may be configured to repeatedly detect the optical interference pattern, determine a relative orientation and/or separation of the first and second optical reflectors based on the detected optical interference pattern, and move the first and second optical reflectors relative to each other to change the relative orientation and/or separation of the first and second optical reflectors based on the determined relative orientation and/or separation, until the desired relative orientation and/or separation is attained.

In some embodiments, the optical microcavity is configured for stable resonance in at least one mode, and the EM radiation source is configured for illuminating the optical microcavity with EM radiation to cause resonance within the optical microcavity. However, for some embodiments of the optical microcavity device, resonance is not required, only multi-pass or multi-path interference.

In some embodiments, the recess may have a radius of curvature of 50 μm or less.

In some embodiments, the optical microcavity may have an optical mode volume of 10 μm³ or less.

In some embodiments, the optical microcavity device is a sensor, for example a sensor for detecting or characterising nanoparticles, a chemical sensor, a seismometer or a strain gauge. The open space may be configured to receive a sample to be sensed, for example a fluid sample, or a solid sample, for example fixed on a surface.

In other embodiments, the optical microcavity device may be a light source with application-specific properties. For example, a fluorescent material provided in the open space may be caused to emit into a cavity mode, with applications in spectroscopy and quantum simulation or computation.

The alignment system may be further configured to:

detect the optical interference pattern for at least two different relative orientations and/or separations of the first and second optical reflectors and/or at two or more different frequencies of EM radiation;

determine a difference between the detected optical interference patterns; and

determine the relative orientation and/or separation of the first and second optical reflectors based on the difference between the detected optical interference patterns.

Determining a difference between the optical interference patterns detected at two different relative orientations and/or separations of the first and second optical reflectors may be useful in determining the relative orientation of the first and second optical reflectors, including both the magnitude and sense of a relative angle between the alignment reflectors. In embodiments in which the first and second alignment reflectors are planar, an optical interference pattern detected at a single relative orientation and/or separation of the first and second optical reflectors would not be sufficient to determine the sense of a relative angle between the first and second alignment reflectors.

Determining a difference between the optical interference patterns detected at two different frequencies of EM radiation may be useful in determining the separation of the first and second optical reflectors, for example by determining the difference in position of fringes in the interference pattern obtained at each frequency. Combining this with detection of the optical interference pattern for at least two different relative orientations and/or separations of the first and second optical reflectors may further be useful in overcoming an ambiguity in the determination of separation between the optical reflector of half-integer units of the wavelength of the EM radiation used by the alignment system to illuminate the first and second alignment reflectors.

In some embodiments, at least one of the first and second alignment reflectors comprises an alignment structure comprising at least two reflective surface portions having different angular orientations, and the alignment system is configured to detect an optical interference pattern by detecting the optical interference patterns generated by each of said at least two reflective surface portions of the alignment structure.

This may be useful in enabling the alignment system to determine the relative orientations of the first and second optical reflectors from an interference pattern detected at a single relative orientation of the first and second optical reflectors, and may improve the speed, accuracy and/or reliability with which the alignment system operates. The alignment structure may also increase the range over which the relative orientation of the first and second optical reflectors can be determined, which may be useful when the reflectors are very misaligned.

The at least two reflective surface portions of the alignment structure may be provided by two or more distinct reflective surfaces at different angular orientations, or by at least one continuous surface having a varying angular orientation.

In some embodiments, the alignment structure has a configuration which effectively defines a plane. For example, a plane may effectively be defined relative to two planar portions, each sloping at an equal but opposite angle to the plane, and cutting the plane at, for example, their lower edges. A plane may also be effectively defined relative to a cone, the cone having a symmetry axis orthogonal to the plane and an end point at a predetermined spacing from the plane. In such configurations, the alignment system may be used to align a plane effectively defined by the alignment structure on one of the first and second alignment reflectors with the other one of the first and second alignment reflectors.

The alignment structure may comprise at least one of the following configurations:

(i) wherein the at least two reflective surface portions comprise at least two planar reflectors having different angular orientations;

(ii) wherein the at least two reflective surface portions comprise surfaces of a pyramid-shaped structure;

(iii) wherein the at least two reflective surface portions are provided by respective portions of a spherical or spherical-cap surface;

(iv) wherein the at least two reflective surface portions are provided by respective portions of a hyperbolic or saddle-shaped surface; and/or

(v) wherein the at least two reflective surface portions are provided by respective portions of a conical or frusto-conical structure.

By providing an alignment structure comprising planar reflectors (e.g. the surfaces of a pyramid), an interference pattern comprising fringes with a simple periodic pattern is obtained, which can be analysed with relative ease. Spherical and spherical-cap surfaces or structures (including structures having surfaces corresponding to parts of a spherical surface, e.g. hem i-spherical) may be useful as the fringes obtained from spherical surfaces are always circular, and therefore relatively simple to detect, even if they are not equally spaced. By providing a conical or frusto-conical alignment structure, an interference pattern comprising elliptical fringes may be obtained, in which one focus of the ellipse is centred on the cone, and the eccentricity of the elliptical fringes indicates an angle of a plane orthogonal to the axis of the cone. These elliptical fringes may be used for aligning a plane orthogonal to the axis of the cone relative to a plane defined by the other optical reflector.

In some embodiments, at least one of the first and second alignment reflectors comprises an alignment structure comprising an array of recesses, said first and second alignment structures providing a corresponding array of optical microcavities, and the alignment system is configured to detect an optical interference pattern by detecting the optical interference pattern generated by said array of optical microcavities.

For example, the array of recesses may comprise an array of concave recesses arranged in a closely-packed structure. Transmission occurs at the optical modes of each optical microcavity corresponding to a respective recess. In addition, an interference pattern across the array of optical microcavities may be detected when the angle between the first and second alignment reflectors is non-zero. The interference pattern may be in the form of fringes having a periodicity dependent on the relative angle between the first and second alignment reflectors.

In such embodiments, the recess of the second cavity reflector may be provided by one of the recessed of said array of recesses. This may simplify an optical microcavity device in which the second cavity reflector comprises an optical microcavity array, in that the first and second alignment reflectors may be provided by the same structures as the first and second cavity reflectors, and a single EM radiation source may be used both for illuminating the optical microcavities to cause multi-pass interference within each optical microcavity (e.g. to operate the device as a sensor), and for illuminating the first and second alignment reflectors to generate an optical interference pattern (i.e. for aligning the first and second optical reflectors).

The actuator system may comprise a plurality of actuators arranged to adjust the position and relative orientation of at least one of the first and second optical reflectors. In some embodiments, the actuators may have a resolution of less than 100 nm. In some embodiments, the actuators may comprise piezo-inertial actuators. In some embodiments, multiple actuator types may be combined, for example a standard piezo actuator plus a piezo-inertial actuator, or a piezo plus a stepper motor.

The alignment system may comprise a control device for controlling the actuator system, wherein the control device is configured to adjust the relative orientations of the optical reflectors without adjusting the separation between the optical reflectors.

By controlling the actuators to adjust the relative angular orientations of the optical reflectors without adjusting the optical cavity length, the relative orientations of the optical reflectors may be corrected prior to approaching the reflectors towards each other. This may be useful due to the proximity of the optical reflectors required to achieve a short optical cavity, which can lead to collision between the first and second optical reflectors if they are moved towards each other without first ensuring that a relative angle between the optical reflectors is sufficiently small. This feature may also be useful for adjusting the alignment of the optical microcavity without significantly changing the cavity length.

The alignment system may comprise an EM radiation source for illuminating the first and second alignment reflectors of the respective first and second optical reflectors to generate an optical interference pattern, wherein the EM radiation source of the alignment system is either the same or different from the EM radiation source configured for illuminating the optical microcavity with EM radiation to cause multi-pass interference within the optical microcavity.

The alignment system may comprise an EM radiation source for illuminating the first and second alignment reflectors of the respective first and second optical reflectors to generate an optical interference pattern, wherein the EM radiation source of the alignment system comprises one or more low coherence light sources.

By low coherence, we mean that the EM radiation source of the alignment system may simultaneously excite multiple non-degenerate or quasi-degenerate modes of the optical cavity formed between the alignment reflectors. For example, the EM radiation source of the alignment system may comprise an LED.

The alignment system may comprise image capture and image analysis components configured to:

capture an image of the optical interference pattern; and

determine at least one parameter of the optical interference pattern.

The at least one parameter may comprise a spatial frequency of the optical interference pattern.

The spatial frequency of the optical interference pattern may be determined from a single image of the optical interference pattern, or from a difference image obtained by subtracting a first image of the optical interference pattern from a second image of the optical interference pattern obtained by changing the relative separation of the optical reflectors by a small amount (typically by less than one quarter of a wavelength of the EM radiation illuminating the first and second alignment reflectors in the intra-cavity medium) to shift the interference pattern by a correspondingly small amount (i.e. by less than half a fringe). The spatial frequency of the optical interference pattern may be determined, for example, by obtaining a 2D Fourier transform or an autocorrelation function of the image of the optical interference pattern (either the single image or the difference image). The image capture and image analysis components may be configured for filtering the image of the optical interference pattern, and/or for filtering the 2D Fourier transform or autocorrelation function. Further computational image analysis techniques may also be used, including general image feature recognition methods such as Hough transforms, least squares regression fitting, pattern or template matching, or machine-learning methods.

In embodiments in which an elliptical fringe pattern is produced, the at least one parameter determined by the image analysis components of the alignment system may comprise the foci and/or major and minor axes and/or the eccentricity of the elliptical fringe pattern.

In some embodiments, the optical microcavity device further comprises a detector arranged to detect EM radiation from the optical microcavity. The detector may be a photodiode. Alternatively, the detector may be provided by the image capture and image analysis components configured to capture an image of the optical interference pattern.

The alignment system may be configured to determine and correct the relative orientation and/or separation of the first and second optical reflectors at predetermined time intervals and/or in response to predetermined events.

For example, in embodiments in which the optical microcavity device is a sensor, the alignment system may be configured to determine and, if necessary, to correct the relative orientation and/or separation of the first and second optical reflectors prior to a measurement by the optical microcavity device. As another example, during a measurement using the optical microcavity device in the form of a sensor, the alignment system may be configured to determine and correct the relative orientation and/or separation of the first and second optical reflectors in response to a measured or inferred signal being outside of a pre-defined range. The measured or inferred signal may be a difference between the resonant frequencies of two nearby optical microcavities, which depends directly on the angle between the first and second optical reflectors along an axis between the microcavities.

The alignment system may be configured to determine and correct the relative orientation and/or separation of the first and second optical reflectors during a process for manufacturing the optical microcavity device.

The alignment system may be configured to determine and correct the relative orientation and/or separation of the first and second optical reflectors prior to and/or while bonding the first and second reflectors to each other.

According to another aspect of the present disclosure, there is provided an optical microcavity device comprising:

a first optical reflector;

a second optical reflector opposed to the first optical reflector along an optical axis, the opposed first and second optical reflectors being spaced apart from each other forming an open space therebetween;

wherein the first optical reflector comprises a first cavity reflector and a first alignment reflector,

wherein the second optical reflector comprises a second cavity reflector and a second alignment reflector, the second cavity reflector comprising a recess to provide an optical microcavity between the first and second cavity reflectors, the optical microcavity having an optical cavity length of at most 50 μm and/or an optical mode volume of 100 μm³ or less; and

an EM radiation source configured for illuminating the optical microcavity with EM radiation to cause multipass interference within the optical microcavity;

wherein at least one of the first and second alignment reflectors comprises an alignment structure comprising at least two reflective surface portions having different angular orientations.

According to another aspect of the present disclosure, there is provided an alignment system for an optical microcavity device, the optical microcavity device comprising:

a first optical reflector comprising a first cavity reflector and a first alignment reflector;

a second optical reflector opposed to the first optical reflector along an optical axis, the first and second optical reflectors being spaced from each other forming an open space therebetween, the second optical reflector comprising a second cavity reflector and a second alignment reflector, the second cavity reflector comprising a recess to provide an optical microcavity between the first and second cavity reflectors,

the optical microcavity having an optical cavity length of at most 50 μm and/or an optical mode volume of 100 μm³ or less;

the alignment system being configured to:
illuminate the first and second alignment reflectors of the first and second optical reflectors to generate an optical interference pattern;
detect the optical interference pattern; and
determine a relative orientation and/or separation of the first and second optical reflectors based on the detected optical interference pattern; and

the alignment system further comprising an actuator system configured to move the first and second optical reflectors relative to each other to change the relative orientation and/or separation of the first and second optical reflectors based on the determined relative orientation and/or separation.

According to another aspect of the present disclosure, there is provided a method for aligning an optical device, the optical device comprising:

a first optical reflector comprising a first cavity reflector and a first alignment reflector;

a second optical reflector opposed to the first optical reflector along an optical axis, the first and second optical reflectors being spaced from each other forming an open space therebetween, the second optical reflector comprising a second cavity reflector and a second alignment reflector;

the method comprising:
illuminating the first and second alignment reflectors of the first and second optical reflectors with EM radiation to generate an optical interference pattern;
detecting, by a sensor, the optical interference pattern; and
determining, by a processing device, a relative orientation and/or separation of the first and second optical reflectors based on the detected optical interference pattern; and
controlling the actuator system to move the first and second optical reflectors relative to each other to change the relative orientation and/or separation of the first and second optical reflectors based on the determined relative orientation and/or separation.

The method may further comprise:

after the step of controlling the actuator system, bonding the first and second optical reflectors to each other at a fixed relative orientation and separation; and

removing the alignment system from the optical microcavity device.

Bonding the first and second optical reflectors may include applying an adhesive to the first and second optical reflectors, glass frit bonding or glass soldering.

The method may further comprise:

applying an adhesive to the first and second optical reflectors for bonding the first and second optical reflectors to each other at a fixed relative orientation and separation;

after applying said adhesive, determining a relative orientation and/or separation of the first and second optical reflectors based on the detected optical interference pattern, and controlling the actuator system to move the first and second optical reflectors relative to each other to change the relative orientation and/or separation of the first and second optical reflectors based on the determined relative orientation and/or separation. This step may be repeated until the first and second optical reflectors are fixedly bonded together at a desired relative orientation and separation.

The adhesive may be a UV-light cured adhesive and the method may further comprise:

irradiating the applied adhesive with UV light to cure the adhesive.

According to a further aspect of the present disclosure, there is provided an optical microcavity device comprising:

a first optical reflector;

a second optical reflector opposed to the first optical reflector along an optical axis, the first and second optical reflectors being spaced from each other forming an open space therebetween;

wherein the first optical reflector comprises a first cavity reflector and a first alignment reflector,

wherein the second optical reflector comprises a second cavity reflector and a second alignment reflector;

an EM radiation source configured for illuminating the first and second cavity reflectors with EM radiation to cause multi-pass interference between the first and second cavity reflectors; and

an alignment system configured to:
illuminate the first and second alignment reflectors of the first and second optical reflectors to generate an optical interference pattern;
detect the optical interference pattern; and
determine a relative orientation and/or separation of the first and second optical reflectors based on the detected optical interference pattern;

the alignment system further comprising an actuator system configured to move the first and second optical reflectors relative to each other to change the relative orientation and/or separation of the first and second optical reflectors based on the determined relative orientation and/or separation.

According to another aspect of the present disclosure, there is provided an optical microcavity device comprising:

a first optical reflector;

a second optical reflector opposed to the first optical reflector along an optical axis, the opposed first and second optical reflectors being spaced apart from each other forming an open space therebetween;

wherein the first optical reflector comprises a first cavity reflector and a first alignment reflector,

wherein the second optical reflector comprises a second cavity reflector and a second alignment reflector; and

an EM radiation source configured for illuminating the first and second cavity reflectors with EM radiation to cause multi-pass interference between the first and second cavity reflectors;

wherein at least one of the first and second alignment reflectors comprises an alignment structure comprising at least two reflective surface portions having different angular orientations.

According to another aspect of the present disclosure, there is provided an alignment system for an optical microcavity device, the optical microcavity device comprising:

a first optical reflector comprising a first cavity reflector and a first alignment reflector;

a second optical reflector opposed to the first optical reflector along an optical axis, the first and second optical reflectors being spaced from each other forming an open space therebetween, the second optical reflector comprising a second cavity reflector and a second alignment reflector;

the alignment system being configured to:
illuminate the first and second alignment reflectors of the first and second optical reflectors to generate an optical interference pattern;
detect the optical interference pattern; and
determine a relative orientation and/or separation of the first and second optical reflectors based on the detected optical interference pattern; and

the alignment system further comprising an actuator system configured to move the first and second optical reflectors relative to each other to change the relative orientation and/or separation of the first and second optical reflectors based on the determined relative orientation and/or separation.

### BRIEF DESCRIPTION OF THE DRAWINGS

FIG. 1 schematically illustrates an optical microcavity device according to an embodiment of this disclosure;

FIG. 2 schematically illustrates a part of the optical microcavity device of FIG. 1;

FIG. 3 (a) to (e) illustrates successive relative positions of the first and second optical reflectors of the optical microcavity device of FIG. 1, and corresponding detected interference patterns during alignment of the first and second optical reflectors by an alignment system, according to an embodiment of this disclosure;

FIG. 4 (a) to (d) illustrates detection of an optical interference pattern by an alignment system according to an embodiment of this disclosure;

FIG. 5(a) illustrates first and second optical reflectors of an optical microcavity device according to an embodiment of this disclosure, in which the first optical reflector comprises an alignment structure, and FIG. 5(b) illustrates an optical interference pattern generated using the first and second optical reflectors of FIG. 5(a);

FIG. 6 (a) to (f) illustrate various configurations of first and second optical reflectors of optical microcavity devices according to embodiments of this disclosure;

FIG. 7 (a) illustrates a second optical reflector of an optical microcavity device according to an embodiment of this disclosure, in which the first optical reflector comprises an alignment structure comprising an array of recesses, and FIGS. 7 (b) and (c) illustrate optical interference patterns generated using the second optical reflector of FIG. 7(a); and

FIG. 8 illustrates steps of a method of use of an alignment system during a process for manufacturing an optical microcavity device 10′ according to an embodiment of this disclosure.

### DETAILED DESCRIPTION

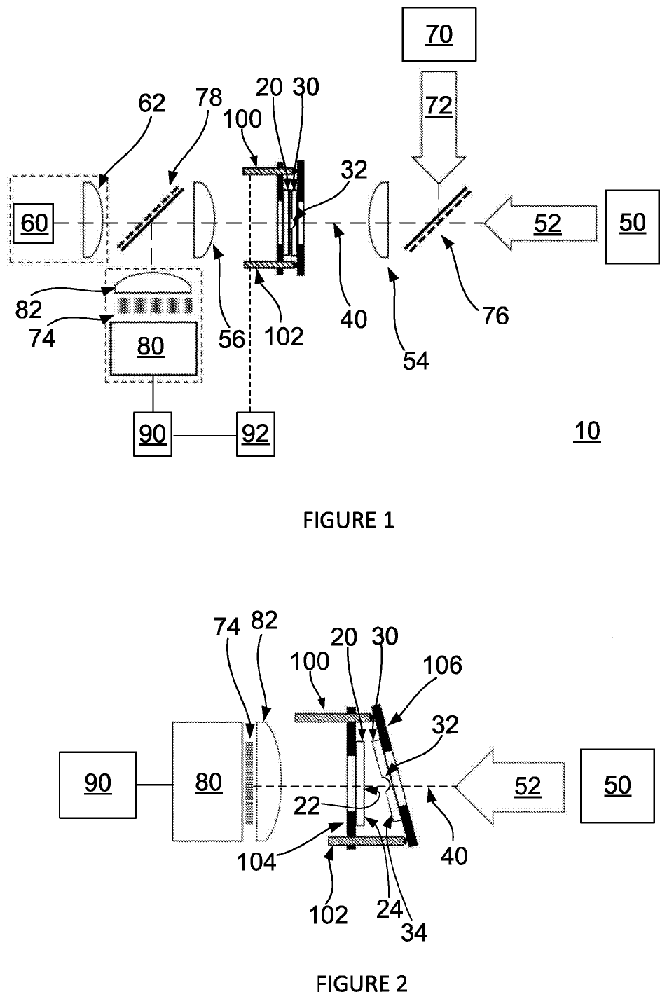

FIG. 1 shows an optical microcavity device including an alignment system according to an embodiment of this disclosure. The optical microcavity device 10 comprises a first optical reflector 20 and a second optical reflector 30. FIG. 2 shows the first and second optical reflectors 20, 30 and components of the alignment system in more detail. The second optical reflector 30 is opposed to the first optical reflector 20 along an optical axis 40. The first and second optical reflectors 20, 30 are spaced apart from each other forming an open space therebetween. The first optical reflector 20 comprises a first cavity reflector 22 and a first alignment reflector 24. The second optical reflector 30 comprises a second cavity reflector 32 and a second alignment reflector 34. Each of the first and second optical reflectors 20, 30 must both be partially transmissive. Dielectric or metal films coated onto the inner face of a respective substrate are suitable. In the optical microcavity device 10 illustrated in FIGS. 1 and 2, the first cavity reflector 22 is planar, with the first cavity reflector 22 and first alignment reflector 24 being provided by portions of a continuous planar surface of the first optical reflector 20. The second cavity reflector 32 comprises a recess to provide an optical microcavity between the first and second cavity reflectors 22, 32. The second alignment reflector 34 comprises a planar portion of the second optical reflector 30 adjacent to or surrounding the second cavity reflector 32. When the first and second optical reflectors 20, 30 are correctly aligned, the optical microcavity has an optical cavity length of at most 50 microns, and/or an optical mode volume of 10 cubic microns or less. Typically, the optical cavity length is between 0.7 microns and 5 microns, and the recess has a radius of curvature between 4 microns and 50 microns (e.g. for the 4th to 30th longitudinal mode at a wavelength of 500 nm in water), which results in approximate mode volumes in the range 0.09 to 13 cubic microns when varying the wavelength in the range 500 to 650 nm. For example, for the 8^{th} longitudinal cavity mode using 640 nm light, a recess with a radius of curvature of 20 microns could be used to provide a microcavity having a cavity length of 1.7 microns and cavity mode volume of 1.06 cubic microns.

The optical microcavity device 10 further comprises an electromagnetic (EM) radiation source 50 configured for illuminating the optical microcavity with an electromagnetic radiation beam 52 to cause multi-pass interference within the optical microcavity. Imaging optics in the form of an input lens 54 and an output lens 56 may be provided for focussing the beam 52. The input lens 54 and output lens 56 may be arranged in a confocal configuration. The optical microcavity is generally configured for stable resonance in at least one mode, and the EM radiation source 50 and/or the cavity length is tuned or tunable to cause resonance within the optical microcavity. However, in some applications, resonance may not be required.

A detector 60, for example a photodiode, is arranged to detect electromagnetic radiation from the optical microcavity. Further imaging optics in the form of a lens 62 may be provided for focussing radiation from the optical microcavity onto the detector 60. In some embodiments, multiple detectors 60 may be provided. By detecting the electromagnetic radiation from the optical microcavity, the optical microcavity device 10 may function as a sensor, for example a seismometer, a strain gauge, or a sensor for detecting and measuring the properties of particles or chemicals. The open space between the optical reflectors 20, 30 may provide a sample space for receiving a fluid or solid sample. However, in some embodiments of the device, for example a device for use as a light source, the detector 60 may not be required.

The optical microcavity device 10 further comprises an alignment system, comprising a further electromagnetic (EM) radiation source 70 configured to illuminate the first and second alignment reflectors 24, 34 with an electromagnetic radiation beam 72 to generate an optical interference pattern 74. In some embodiments, the EM radiation source 70 is an LED. The EM radiation source 70 may comprise multiple sources, for example multiple LEDs, or may be tunable for changing the frequency of the beam 72. In one embodiment, the two EM radiation beams 52, 72 have different wavelengths to increase transmission of the EM radiation beam 72 of the alignment system. The wavelength of the EM radiation beam 72 of the alignment system is centred at the edge of the stop-band of the dielectric mirrors forming the first and second alignment reflectors 24, 34, while the wavelength of the EM radiation beam 52 for illuminating the optical microcavity is selected to be at the centre of the stop-band. A beam splitter 76 is provided for combining the two EM radiation beams 52, 72 so that both illuminate the optical reflectors 20, 30. The beam splitter 76 is a dichroic beam splitter, taking account of the different wavelengths of the two EM radiation beams 52, 72. However, a simple non-polarising beam splitter could be used. A further beam splitter 78 is provided for separating the two EM radiation beams 52, 72 for detection by the detector 60 and sensor 80 respectively. Additional filters (not shown) are used to further improve the wavelength selection at the detector 60 and sensor 80. In other embodiments, the two electromagnetic radiation sources 50, 70 may be replaced by a single electromagnetic radiation source, for example an LED or other low coherence light source, or by a single source with broad spectrum but high coherence, such as a pulsed, mode-locked laser or a frequency comb.

The alignment system further comprises image capture and processing components in the form of a sensor 80 and processor 90. The sensor 80 is configured to detect the optical interference pattern 74 and to output data representing the optical interference pattern 74 to the processor 90. Imaging optics in the form of a lens 82 may be provided for focussing the optical interference pattern 74 onto the sensor 80. The processor 90 is configured to determine a relative orientation and/or separation of the first and second optical reflectors 20, 30 based on the optical interference pattern 74 detected at the sensor 80. In some embodiments, the detector 60 and sensor 80 may be replaced by a single sensor, with suitable discrimination between the two EM radiation beams 52, 72 (e.g. a colour sensor if the two EM radiation beams 52, 72 are different colours, temporal multiplexing or spatial resolution using different pixels of a detector array).

The alignment system further comprises an actuator system comprising actuators 100, 102 configured to move the first and second optical reflectors 20, 30 relative to each other to change the relative orientation and/or separation of the first and second optical reflectors 20, 30 based on the determined relative orientation and/or separation. Although only two actuators 100, 102 are shown in FIG. 1, at least a third actuator (not shown) is provided for changing the angle of the first optical reflector 20 relative to the second optical reflector 30 about a further axis. The actuator system also comprises mounts 104, 106 to which the first and second optical reflectors 20, 30 are respectively fixed. The mounts 104, 106 may, for example, be kinematic mounts, flexure mounts, gimbal mounts, or the like, and may be installed in an optical cage mount. In this embodiment, the actuators 100, 102 are arranged to move the mount 106 holding the second optical reflector 30, while the mount 104 holding the first optical reflector 20 remains stationary. Each actuator 100, 102 may be in the form of a precision screw rotatable by means of a piezo-inertial actuator having a range of several millimetres (for example, Picomotor™ Actuators commercialised by New Focus™). The actuator system may be configured for moving the first and second optical reflectors 20, 30 relative to each other with a resolution or step size of less than 100 nm. A control device 92, in data communication with the processor 90, may be provided for controlling the actuator system.

The control device 92 may be configured to adjust the relative orientations of the first and second optical reflectors without adjusting the separation between the optical reflectors 20, 30, by coordinating the motion of two or more of the actuators 100, 102 at a time, so that it is possible to adjust the orientation and separation of the optical reflectors 20, 30 in separate steps. This may also be useful in reducing the likelihood of the two optical reflectors 20, 30 colliding with each other, which could cause the optical reflectors 20, 30 to become damaged or adhere to each other.

In the embodiment illustrated in FIGS. 1 and 2, the alignment reflectors 24, 34 of the first and second optical reflectors 20, 30 are planar reflectors. The first alignment reflector 24 is continuous with the first cavity reflector 22. However, alternative configurations will be discussed below.

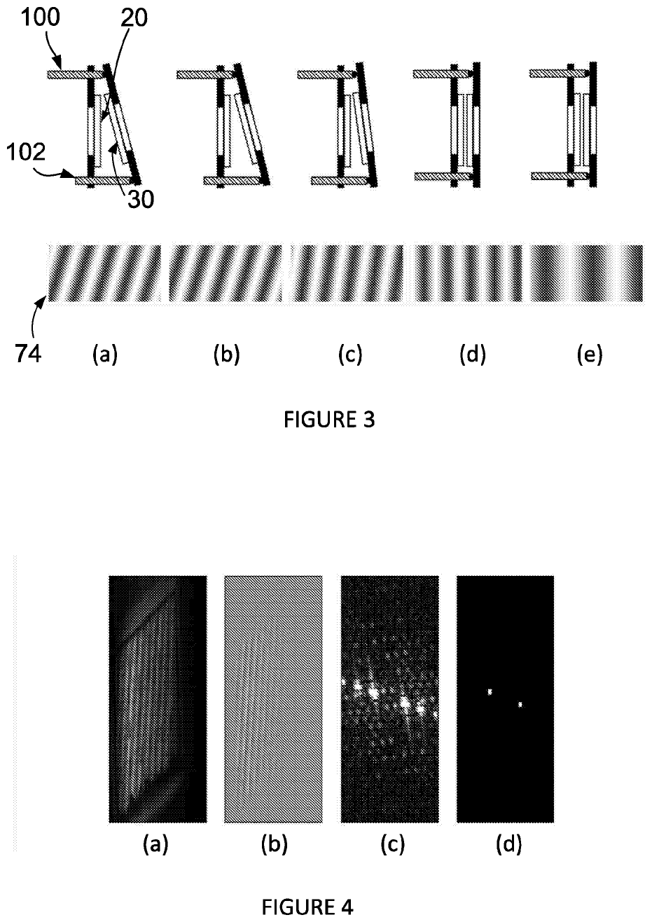

FIGS. 3a to e illustrate an example of successive relative positions of the first and second optical reflectors 20, 30 (top), and the corresponding interference patterns 74 detected by the alignment system (bottom) during alignment of the first and second optical reflectors 20, 30 by the alignment system. FIG. 3a illustrates an initial position of the first and second optical reflectors 20, 30 (top image) and the corresponding interference pattern 74 (bottom image) detected by the alignment system. The spacing and orientation of the fringes along each axis of the detected interference pattern indicates a relative angle of the first and second optical reflectors 20, 30 about a corresponding axis. Thus, the separation of the fringes in the interference pattern 74 shown in FIG. 3a enables determination of a relative orientation of the first and second optical reflectors 20, 30. However, the sense of the angle between the first and second optical reflectors 20, 30 cannot be determined from the interference pattern 74 shown in FIG. 3a alone.

Although an image of the interference pattern 74 shown in FIG. 3a can be analysed directly to obtain the fringe spacing, accuracy may be improved by processing the image of the interference pattern to eliminate any artefacts or background features which may appear in practice, such as the edges of the first and second reflectors 20, 30. This may be achieved by obtaining a difference image by subtracting a first image of the optical interference pattern 74 (e.g. the image shown in FIG. 3a) from a second image of the optical interference pattern 74 obtained after changing the relative separation of the first and second optical reflectors 20, 30 to shift the interference pattern by a small amount (e.g. of the order of 1/10th) of a wavelength of the fringe pattern. FIG. 3b illustrates the relative orientations of the first and second optical reflectors 20, 30 (top) and a second image of the corresponding interference pattern 74 (bottom) after a very small change in separation of the first and second optical reflectors 20, 30 such that the interference pattern shown in FIG. 3b is shifted only slightly relative to that of the interference pattern shown in FIG. 3a. In this example, a movement of one actuator by about 30 nm, corresponding to approximately 1/12th of a wavelength of light (i.e. much less than the wavelength of light), is used to change the separation between the first and second optical reflectors, although a shift of up to about 100 nm could be used. Although the movement of a single actuator also leads to a small change in relative orientation of the first and second optical reflectors 20, 30 (of about 1 micro-radian in this example), the difference between the interference patterns shown in FIGS. 3a and 3b is mainly due to the change in separation of the first and second optical reflectors 20, 30. It can be seen that the fringes of the interference pattern 74 shown in FIG. 3b have shifted by about 1 radian to the left relative to the interference pattern 74 shown in FIG. 3a. By taking the difference of the images of the interference patterns 74 shown in FIGS. 3a and 3b, an image of the interference pattern 74 relatively free of background artefacts may be obtained. An example will be discussed with reference to FIG. 4b below.

FIG. 3c illustrates the relative orientations of the first and second optical reflectors 20, 30 (top image) and the corresponding interference pattern 74 (bottom image) after a significant change in the relative orientation of the first and second optical reflectors 20, 30, such that the interference pattern shown in FIG. 3c is tilted relative to that of the interference pattern shown in FIG. 3a and has a different fringe spacing. In this example, the shift may be around 25 microns of at least one of the actuators, corresponding to at least 1 mrad in orientation. The shift in the detected optical interference patterns between FIGS. 3a and 3c (or between corresponding difference images, as discussed above in connection with FIGS. 3a and 3b) and the corresponding shift in the relative orientation of the first and second optical reflectors 20, 30 can be used to determine a sense of the relative angle between the first and second optical reflectors 20, 30, which can in turn be used to determine in which direction the second optical reflector 30 should be moved, in order to move the two optical reflectors 20, 30 towards a predetermined configuration. That is, by determining a difference between the optical interference patterns detected at two different relative orientations of the first and second optical reflectors (e.g. FIGS. 3a and 3c), it is possible to determine both the magnitude and sense of the relative orientation of the first and second optical reflectors 20, 30. The shift in the interference pattern can also be used to determine by how much an actuator should be moved to change the relative orientation of the first and second optical reflectors 20, 30 to a predetermined configuration. The shift in relative orientation of the first and second optical reflectors 20, 30 for determining the sense of the relative orientation and/or calibrating the movement of the actuators is sufficiently small that the risk of collision of the first and second optical reflectors 20, 30 is relatively small. Although in this example, the change in relative orientation of the of the first and second optical reflectors 20, 30 between FIG. 3a and FIG. 3c was about half of the total angle between the reflectors, a smaller change (e.g. as small as 1/20th) may be sufficient to determine the sense of the relative orientation of the first and second optical reflectors. As discussed above with reference to FIGS. 3a and 3b, a pair of images (one of which being that shown in FIG. 3c) may be obtained to obtain a difference image of the interference pattern shown in FIG. 3c.

FIG. 3d illustrates the first and second optical reflectors 20, 30 (top) and the corresponding interference pattern 74 (bottom) after a correction of the relative orientation of the first and second optical reflectors 20, 30 by the actuator system, by rotation of the second optical reflector 30 about a first axis (orthogonal to the plane of FIG. 3 (top)) such that the first and second optical reflectors 20, 30 are substantially parallel about the first axis. Accordingly, the fringes of the corresponding interference pattern are substantially parallel to a corresponding axis. The correction corresponds to around several mm of movement of one or more actuators.

FIG. 3e illustrates the first and second optical reflectors 20, 30 (top) and the corresponding interference pattern 74 (bottom) after a further correction of the relative orientation of the first and second optical reflectors 20, 30 by the actuator system, by rotation of the second optical reflector 30 about a second axis (parallel to the plane of FIG. 3 (top)) to move the first and second optical reflectors 20, 30 towards a parallel configuration about the second axis. This is achieved by movement of the third actuator (not shown). The spacing of the interference fringes in the corresponding interference pattern is therefore greater than that shown in FIG. 3d, indicating that the relative angle between the first and second optical reflectors 20, 30 has been reduced.

In the example illustrated by FIG. 3, the alignment system corrects the alignment to a predetermined orientation in a series of only two steps, one for each axis of rotation of the second optical reflector relative to the first optical reflector. However, the alignment may be carried out in a single step or in a series of smaller steps.

The alignment system may also be configured to detect optical interference patterns 74 using two or more different frequencies of EM radiation generated by the EM radiation source 70. Determining a difference between the two or more detected optical interference patterns 74 obtained at non-commensurate frequencies, for example by determining a difference in the position of fringes in the optical interference pattern 74 detected using each frequency, can be used to determine the separation of the first and second optical reflectors 20, 30, overcoming an ambiguity in the determination of separation between the optical reflector of half-integer units of the wavelength of the EM radiation 72 used by the alignment system. Further overdetermination of the exact length by detection of optical interference patterns for several relative orientations and/or separations of the first and second optical reflectors may be useful in overcoming this ambiguity even in the presence of image distortion, detector noise or other instrumental uncertainties.

FIG. 4 (a to d) illustrates detection of the optical interference pattern 74 using image capture and processing components 80, 90 of the alignment system. FIG. 4a illustrates an image of the interference pattern obtained in transmission through the first and second optical reflectors 20, 30 when illuminated by an LED. This image may correspond to any one of the optical interference patterns 74 shown in FIG. 3 (a-e). Although this image is sufficient to determine the fringe spacing, and thus a relative orientation of the first and second optical reflectors 20, 30, accuracy can be improved by subtracting a second image of the interference pattern 74 obtained after shifting the first and second optical reflectors 20, 30 to a slightly different separation, as discussed above with reference to FIG. 3b, to eliminate artefacts such as the edges of the first and second reflectors 20, 30. FIG. 4b illustrates a difference image obtained by subtracting a second image, in which the fringe pattern is shifted by a fraction of a wavelength, from the image shown in FIG. 4a. In this example, the change in separation of the first and second optical reflectors is achieved by a movement of one actuator by about 30 nm, corresponding to approximately 1/12th of a wavelength of light (i.e. much less than the wavelength of light). Further processing of the difference image shown in FIG. 4b is carried out to determine the spatial frequency of the optical interference pattern. Various techniques may be used, for example a 2D Fourier transform or an auto-correlation function. As an example, FIG. 4c shows the 2D Fourier transform of the difference image shown in FIG. 4b. The positions of the bright spots in the 2D Fourier transform indicate the spatial frequency of the fringes (effectively, the 2D wave vector). Further processing may be applied to improve accuracy of determination of the spatial frequencies of the interference pattern, for example by filtering the 2D Fourier transform shown in the FIG. 4c to obtain the filtered 2D Fourier transform shown in FIG. 4d before applying peak-detection algorithms.

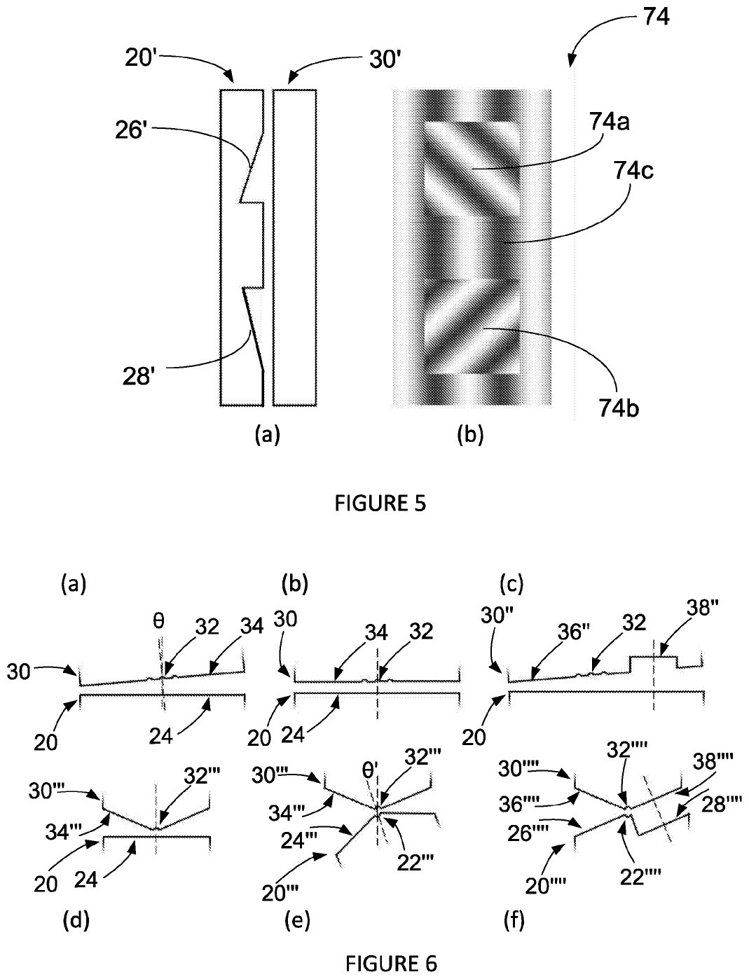

FIG. 5a illustrates first and second optical reflectors 20′, 30′ of the optical microcavity device according to a further embodiment, in which the first alignment reflector 24′ of the first optical reflector 20′ comprises an alignment structure 26′, 28′. For simplicity the recess of the second cavity reflector 32 is not shown. The alignment structure 26′, 28′ comprises at least two reflective surface portions 26′, 28′ having different angular orientations. In the embodiment shown in FIG. 5a, the two reflective surface portions 26′, 28′ are planar reflector portions sloping in opposite directions away from the optical axis 40. The alignment system is configured to detect an optical interference pattern 74 by detecting the optical interference patterns 74a, 74b generated by each of the two reflective surface portions 26′, 28′ of the alignment structure. FIG. 5b illustrates an optical interference pattern 74 detected by the alignment system of the optical microcavity device, and includes the optical interference patterns 74a, 74b generated respectively by each of the two reflective surface portions 26′, 28′ of the alignment structure. The fringes of the interference patterns 74a and 74b are mirror images of each other because the two reflective surface portions 26′, 28′ are at equal and opposite angles relative to the second optical reflector 30′. The fringes of interference patterns 74a and 74b are also rotated relative to the fringes of interference pattern 74c generated by regions of the optical reflectors 20′, 30′ around the angled portions 26′, 28′ of the alignment structure.

The alignment structure shown in FIG. 5a may be useful in that it enables the alignment system to determine the relative orientations of the first and second optical reflectors 20′, 30′ from the interference pattern 74 detected at a single relative orientation of the first and second optical reflectors 20′, 30′. That is, the interference pattern 74 shown in FIG. 5b can be used to determine both the magnitude and sense of the relative angle between the first and second optical reflectors 20′, 30′ because the fringe spacing will be different at each reflective portion unless the first and second optical reflectors 20, 30 are parallel. In some embodiments, the first alignment reflector 24′ of the first optical reflector 20′ may comprise a further pair of alignment structures, arranged orthogonally to the first pair of alignment structures 26′, 28′ shown in FIG. 5a.

Various other alignment structures are possible, some of which are illustrated in FIG. 6. For example, the alignment structure may comprise two or more distinct surfaces at different angular configurations (e.g. as in FIGS. 6c and 6f), or a single continuous surface having a varying angular orientation (e.g. as in FIGS. 6d and 6e).

In FIGS. 6a and 6b, the first optical reflector 20 is planar, while the second optical reflector 30 comprises a second cavity reflector 32 in the form of multiple recesses surrounded by a planar second alignment reflector 34. In the embodiment shown in FIG. 6a, the desired relative orientation of the first and second optical reflectors 20, 30 is an arbitrary angle θ between the axes normal to each of the alignment reflectors 24, 34, whereas in the embodiment shown in FIG. 6b, the desired alignment of the first and second optical reflectors 20, 30 is such that the first and second alignment reflectors 24, 34 are parallel.

In the embodiment illustrated in FIG. 6c, the first optical reflector 20 is again planar. The second optical reflector 30″ comprises a second cavity reflector 32 in the form of multiple recesses and an alignment structure comprising a first planar region 36″ in which the second cavity reflector 32 is located, and a second planar region 38″ at an angle to the first planar region 36″. The desired alignment of the first and second optical reflectors 20, 30″ is such that the second planar region 38″ is parallel to the planar first optical reflector 20. This results in a pre-determined angle between the first planar region 36″ and the planar first optical reflector 20.

In the embodiment illustrated in FIG. 6d, the first optical reflector 20 is planar, while the second optical reflector 30″ comprises a second alignment reflector 34″ in the form of a conical (effectively frusto-conical) alignment structure 34′″ and a second cavity reflector 32″ in the form of a recess located at the apex of the conical alignment structure 34″. The conical alignment structure 34″ provides multiple reflective surface portions having different angular orientations. The apex and symmetry axis of the conical alignment reflector 34″ effectively define a plane (e.g. the plane orthogonal to the symmetry axis, at a specified offset from the apex) which may be aligned relative to a plane of the first optical reflector 20. In this embodiment, the desired alignment of the first and second optical reflectors 20, 30′″ is such that the plane defined by the conical alignment reflector 34″ is parallel to the planar first optical reflector 20. The interference pattern generated by the conical alignment structure 34″ comprises elliptical fringes, wherein one focus of the ellipse is centred on the apex of the cone. The eccentricity of the elliptical fringes indicates an angle of a plane orthogonal to the symmetry axis of the conical alignment structure relative to the planar first optical reflector 20.

FIG. 6e illustrates an embodiment in which each of the first and second optical reflectors 20′″, 30′″ comprises a respective conical alignment structure 24″, 34′″ and a cavity reflector 22′, 32″ located at the apex of the respective alignment structure 24″, 34″. In this configuration, the desired alignment of the first and second optical reflectors 20′″, 30′″ is such that there is an arbitrary angle θ′ between the symmetry axes of the first and second conical alignment structures 24′″,

FIG. 6f illustrates an embodiment in which each of the first and second optical reflectors 20″″, 30″″ comprises a respective cavity reflector in the form of a recess 22″″, 32″″, and a respective alignment reflector comprising non-symmetric alignment structures. The second alignment structure comprises two reflective surface portions 36″″, 38″″ sloping away from the second cavity reflector 32″″, while the first alignment structure comprises a first reflective surface portion 26″″ sloping away from the first cavity reflector 22″″ and a second reflective surface portion 28″″ parallel to but offset from the first reflective surface portion 26″″. In this embodiment, the desired alignment of the first and second optical reflectors 20″″, 30″″ is such that the reflective surface portion 38″″ of the alignment structure of the second optical reflector 30″″ is parallel to the reflective surface portions 26″″, 28″″ of the alignment structure of the first optical reflector 20″″.

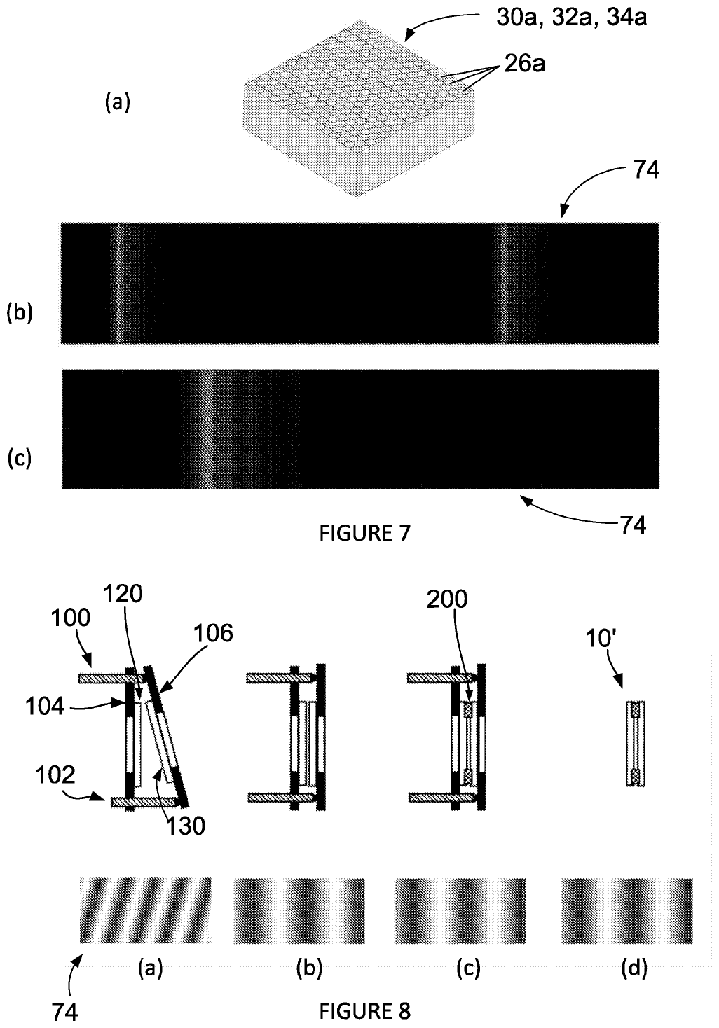

FIG. 7a illustrates a second optical reflector 30a of the optical microcavity device according to a further embodiment in which the second alignment reflector 34a of the second optical reflector 30a comprises an alignment structure in the form of an array of concave recesses 26a, for providing a corresponding array of optical microcavities between the first and second cavity reflectors. In this embodiment, the first alignment reflector of the first optical reflector (not shown) may be provided by planar reflector. The array of recesses 26a may be arranged in a closely packed structure. In this example embodiment, a hexagonal arrangement is used. As an example, the recesses 26a may have a radius of curvature of 10 microns and a separation of 10 microns, all having the same depth.

In this embodiment, the alignment system is configured to detect the optical interference pattern generated by the array of optical microcavities when illuminated with EM radiation. FIG. 7b illustrates a first optical interference pattern 74 detected by the alignment system of the optical microcavity device, with the first and second optical reflectors at a first relative angle. Each optical microcavity of the array features a discretised spectrum and will transmit incoming radiation when illuminated with EM radiation in resonance with an optical mode of the optical microcavity. The transmission by each optical microcavity can itself be considered as an interference pattern as it is generated by interference between the forward and backward propagated waves within the microcavity. Nonetheless, when the second alignment reflector 34a is oriented at a non-zero angle relative to the first alignment reflector, a further interference effect arises across the array of recesses. The resulting interference pattern 74 comprises transmission points (arising from transmission by respective optical microcavities) organised along fringes (arising from interference across the array) as shown in FIG. 7b. The periodicity of the envelope fringes of the interference pattern 74 depends on the relative angle between the first and second alignment reflectors, with neighbouring fringes corresponding to a change in optical length between the first and second alignment reflectors of half the wavelength of the EM radiation illuminating the first and second alignment reflectors, similarly to the case of interference fringes arising between two planar reflectors.

By detecting the interference pattern 74 shown in FIG. 7b, the alignment system may determine the relative orientations of the first and second optical reflectors, for example by using a Fourier transform analysis, a fitting procedure, an autocorrelation or any other suitable algorithmic procedure, as discussed in connection with the embodiments described above. The relative orientation of the first and second optical reflectors may then be adjusted by the alignment system towards a predetermined alignment as described above. FIG. 7c illustrates a second optical interference pattern 74 detected by the alignment system of the optical microcavity device, after adjustment of the relative angle between the first and second alignment reflectors to a second relative angle, smaller than the first relative angle corresponding to the interference pattern of FIG. 7b, resulting in an increased fringe spacing. Additionally, high-finesse modes could be used to increase the accuracy to which the relative angle between the first and second optical reflectors is determined, by increasing the spectral sensitivity to small changes in the relative angle.

The second cavity reflector 32a of the second optical reflector 30a may also be provided one or more of the recesses 26a of the array of recesses 26a. Thus it is not necessary to provide a specific alignment structure in an optical microcavity device relying on an optical microcavity array for its principle function (e.g. as a sensor). Similarly, the first cavity reflector and the first alignment reflector of the first optical reflector (not shown) may be provided by a single reflector portion. In such configurations, a single EM radiation source may be used both for aligning the first and second optical reflectors of the optical microcavity device and for use of the optical microcavity device (e.g. for sensing).

In the above-described embodiments, the alignment structures and cavity recesses of the optical reflectors may be produced by using focused ion beam milling to ablate the surface of a substrate prior to coating with a reflective material, or with several pairs of layers of dielectric materials with alternating refractive index and controlled thickness, to form an optical reflector at the designed operating wavelengths. The alignment structures could also be produced using other techniques such as wet etching or laser ablation.

The alignment system may be used to repeatedly adjust the optical reflectors 20, 30 of the optical microcavity device 10 during manufacture and/or during use of the device 10. For example, the relative alignment of the optical reflectors 20, 30 may be determined, and, if necessary, adjusted by the alignment system at predetermined time intervals or in response to specific events, such as powering on the device or each time the device is used, or if the device's environment (temperature, humidity, air pressure) changes beyond some acceptable range. One example of a specific event could be when a measurement, for example a difference in the determined cavity lengths of neighbouring optical microcavities, falls outside a predetermined range. In the case of an optical microcavity device 10 in the form of a sensing device, a determination and adjustment (if necessary) of the relative alignment of the optical reflectors 20, 30 could be performed prior to each measurement or sample detection.

FIG. 8 illustrates steps of a method of use of an alignment system during a process for manufacturing an optical microcavity device 10′ according to an embodiment of the present disclosure. During this process, a first optical reflector 120 and a second optical reflector 130 are aligned and then bonded to each other in a fixed configuration prior to removal of the alignment system. FIG. 8a (top) illustrates an initial relative orientation and separation of the first and second optical reflectors 120, 130, and FIG. 8a (bottom) illustrates an optical interference pattern 74 generated by illuminating the first and second alignment reflectors of the first and second optical reflectors 120, 130, and which is detected by the sensor 80 of the alignment system. Based on the detected optical interference pattern 74, the alignment system determines a relative orientation and/or separation of the first and second optical reflectors 120, 130, and controls the actuator system 100, 102 to move the first and second optical reflectors 120, 130 relative to each other to change the relative orientation and/or separation of the first and second optical reflectors 120, 130 to the corrected configuration illustrated in FIG. 8b (top). The corresponding optical interference pattern 74 generated in the corrected configuration is illustrated in FIG. 8b (bottom) and is detected by the alignment system to confirm that the corrected configuration corresponds to the desired orientation and/or separation of the first and second optical reflectors 120, 130. An adhesive 200 is then applied to the first and second optical reflectors 120, 130 for bonding the two optical reflectors 120, 130 at the desired orientation and/or separation, as shown in FIG. 8c. The adhesive 200 is applied between the two optical reflectors 120, 130, close to their edges or corners. Optionally, the relative alignment of the first and second optical reflectors 120, 130 may be determined and corrected one or more times while the adhesive 200 hardens to fix the relative orientation and separation of the optical reflectors 120, 130. The adhesive 200 may comprise, for example, a UV-cured adhesive, and the alignment system may be used to determine and correct the relative alignment of the first and second optical reflectors 120, 130 one or more times during curing of the adhesive, during which time the adhesive 200 is irradiated with UV light. As illustrated in FIG. 8d (top), once the adhesive 200 has hardened and the first and second optical reflectors 120, 130 are fixed in position relative to each other, the alignment system, in particular the actuator system including the mounts 104, 106 and actuators 100, 102, may be removed, leaving a compact optical microcavity device 10′. The optical interference pattern 74 may be checked once more before removal of the alignment system.

Although the embodiments described above comprise an optical microcavity device in which at least one of the optical reflectors includes a cavity reflector comprising a recess having a radius of curvature of at most 50 μm, the first and second cavity reflectors forming an optical microcavity having an optical cavity length of at most 50 μm and/or an optical mode volume of 10 μm³ or less, the present disclosure is also applicable to optical devices which do not necessarily include a microcavity. In particular, optical devices in which the first and second optical reflectors have a small separation, for example under 100 microns, would be difficult to align manually.

Although particular embodiments of this disclosure have been described, it will be appreciated that many modifications, additions and/or substitutions may be made within the scope of the claims.

1. An optical microcavity device comprising:
a first optical reflector;
a second optical reflector opposed to the first optical reflector along an optical axis, the first and second optical reflectors being spaced from each other forming an open space therebetween;
wherein the first optical reflector comprises a first cavity reflector and a first alignment reflector,
wherein the second optical reflector comprises a second cavity reflector and a second alignment reflector, the second cavity reflector comprising a recess to provide an optical microcavity between the first and second cavity reflectors, the optical microcavity having an optical cavity length of at most 50 μm and/or an optical mode volume of 100 μm³ or less;
an EM radiation source configured for illuminating the optical microcavity with EM radiation to cause multi-pass interference within the optical microcavity; and
an alignment system configured to:
illuminate the first and second alignment reflectors of the first and second optical reflectors to generate an optical interference pattern;
detect the optical interference pattern; and
determine a relative orientation and/or separation of the first and second optical reflectors based on the detected optical interference pattern;
the alignment system further comprising an actuator system configured to move the first and second optical reflectors relative to each other to change the relative orientation and/or separation of the first and second optical reflectors based on the determined relative orientation and/or separation.

2. An optical microcavity device according to claim 1, wherein the alignment system is further configured to:
detect the optical interference pattern for at least two different relative orientations and/or separations of the first and second optical reflectors and/or at two or more different frequencies of EM radiation;
determine a difference between the detected optical interference patterns; and
determine the relative orientation and/or separation of the first and second optical reflectors based on the difference between the detected optical interference patterns.

3. An optical microcavity device according to claim 1, wherein:
at least one of the first and second alignment reflectors comprises an alignment structure comprising at least two reflective surface portions having different angular orientations, and
the alignment system is configured to detect an optical interference pattern by detecting the optical interference patterns generated by at least two of said at least two reflective surface portions of the alignment structure.

4. An optical microcavity device according to claim 3, wherein, the at least two reflective surface portions of the alignment structure may be provided by two or more distinct reflective surfaces at different angular orientations, or by at least one continuous surface having a varying angular orientation.

5. An optical microcavity device according to claim 3, wherein the alignment structure comprises at least one of the following configurations:
(i) wherein the at least two reflective surface portions comprise at least two planar reflectors having different angular orientations;
(ii) wherein the at least two reflective surface portions comprise surfaces of a pyramid-shaped structure;
(iii) wherein the at least two reflective surface portions are provided by respective portions of a spherical or spherical-cap structure;
(iv) wherein the at least two reflective surface portions are provided by respective portions of a hyperbolic or saddle-shaped surface; and/or
(v) wherein the at least two reflective surface portions are provided by respective portions of a conical or frusto-conical structure.

6. An optical microcavity device according to claim 1, wherein:
at least one of the first and second alignment reflectors comprises an alignment structure comprising an array of recesses, said first and second alignment structures providing a corresponding array of optical microcavities, and
the alignment system is configured to detect an optical interference pattern by detecting the optical interference pattern generated by said array of optical microcavities.

7. An optical microcavity device according to claim 1,
wherein the alignment system includes a control device for controlling the actuator system, wherein the control device is configured to adjust the relative orientations of the optical reflectors without adjusting the separation between the optical reflectors.

8. An optical microcavity device according to according to claim 1,
wherein the alignment system comprises an EM radiation source for illuminating the first and second alignment reflectors of the respective first and second optical reflectors to generate an optical interference pattern, wherein the EM radiation source of the alignment system comprises one or more low coherence light sources.

9. An optical microcavity device according to claim 1,
wherein the alignment system comprises image capture and image analysis components configured to:
capture an image of the optical interference pattern; and
determine a spatial frequency and/or at least one other parameter of the optical interference pattern.

10. An optical microcavity device according to claim 1,
wherein the alignment system is configured to determine and correct the relative orientation and/or separation of the first and second optical reflectors at predetermined time intervals and/or in response to predetermined events.

11. An optical microcavity device according to claim 1,
wherein the alignment system is configured to determine and correct the relative orientation and/or separation of the first and second optical reflectors during a process for manufacturing the optical microcavity device.

12. An optical microcavity device according to claim 11,
wherein the alignment system is configured to determine and correct the relative orientation and/or separation of the first and second optical reflectors prior to and/or while bonding the first and second reflectors to each other.

13. An optical microcavity device comprising:
a first optical reflector;
a second optical reflector opposed to the first optical reflector along an optical axis, the opposed first and second optical reflectors being spaced apart from each other forming an open space therebetween;
wherein the first optical reflector comprises a first cavity reflector and a first alignment reflector,
wherein the second optical reflector comprises a second cavity reflector and a second alignment reflector, the second cavity reflector comprising a recess to provide an optical microcavity between the first and second cavity reflectors, the optical microcavity having an optical cavity length of at most 50 μm and/or an optical mode volume of 100 μm³ or less; and
an EM radiation source configured for illuminating the optical microcavity with EM radiation to cause multipass interference within the optical microcavity;
wherein at least one of the first and second alignment reflectors comprises an alignment structure comprising at least two reflective surface portions having different angular orientations.

14. An alignment system for an optical microcavity device comprising:
a first optical reflector comprising a first cavity reflector and a first alignment reflector;
a second optical reflector opposed to the first optical reflector along an optical axis, the first and second optical reflectors being spaced from each other forming an open space therebetween, the second optical reflector comprising a second cavity reflector and a second alignment reflector, the second cavity reflector comprising a recess to provide an optical microcavity between the first and second cavity reflectors, the optical microcavity having an optical cavity length of at most 50 μm and/or an optical mode volume of 100 μm³ or less;
the alignment system being configured to:
illuminate the first and second alignment reflectors of the first and second optical reflectors to generate an optical interference pattern;
detect the optical interference pattern; and
determine a relative orientation and/or separation of the first and second optical reflectors based on the detected optical interference pattern; and
the alignment system further comprising an actuator system configured to move the first and second optical reflectors relative to each other to change the relative orientation and/or separation of the first and second optical reflectors based on the determined relative orientation and/or separation.

15. A method for aligning an optical device, the optical device comprising:
a first optical reflector comprising a first cavity reflector and a first alignment reflector;
a second optical reflector opposed to the first optical reflector along an optical axis, the first and second optical reflectors being spaced from each other forming an open space therebetween, the second optical reflector comprising a second cavity reflector and a second alignment reflector;
the method comprising:
illuminating the first and second alignment reflectors of the first and second optical reflectors with EM radiation to generate an optical interference pattern;
detecting, by a sensor, the optical interference pattern; and
determining, by a processing device, a relative orientation and/or separation of the first and second optical reflectors based on the detected optical interference pattern; and
controlling the actuator system to move the first and second optical reflectors relative to each other to change the relative orientation and/or separation of the first and second optical reflectors based on the determined relative orientation and/or separation.

16. The method of claim 15, further comprising:
after the step of controlling the actuator system, bonding the first and second optical reflectors to each other at a fixed relative orientation and separation; and
removing the alignment system from the optical microcavity device.
